(19) United States
(12) Patent Application Publication
(10) Pub. No.: US 2024/0430502 A1
(43) Pub. Date: Dec. 26, 2024

(54) Method for managing the rendering of a multimedia content

(71) Applicant: ORANGE, Issy-les-Moulineaux (FR)

(72) Inventors: Hervé Marchand, Chatillon Cedex (FR); Olivier Gaste, Chatillon Cedex (FR)

(21) Appl. No.: 18/748,419

(22) Filed: Jun. 20, 2024

(30) Foreign Application Priority Data
Jun. 21, 2023 (FR) 2306399

(51) Int. Cl. H04N 21/2387; H04N 21/2187

(52) U.S. Cl. CPC H04N 21/2387; H04N 21/2187

(57) ABSTRACT

A method for managing the reading by a reading device of a content recorded on a data medium. The method includes, upon a read mode access by the reading device to a content recorded and having been broadcast live, a request to add, during the rendering of the rebroadcast content, a datum representative of a reading of a rebroadcast content if the time between the current broadcasting instant and the rebroadcasting instant is greater than a given time.

### CROSS-REFERENCE TO RELATED APPLICATIONS

This application claims priority to French Patent Application No. FR 2306399, Filed Jun. 21, 2023, the content of which is incorporated herein by reference in its entirety.

### TECHNICAL FIELD

The technical field of the present disclosure is that of digital multimedia contents, namely digital audio and/or video contents, also called audiovisual contents.

The disclosure relates most particularly to a method for managing the reading of a content that has already been broadcast live. Such a content is for example a sport event, a concert, et cetera.

A reading device can be any device capable of receiving multimedia streams, for example a decoder, a cell phone, a tablet, et cetera.

### BACKGROUND

Television channels broadcast transmissions live. These transmissions can be recorded on a data medium which can be local, for example on a data medium associated with the reading device.

The user also has the possibility, using a reading function called “startover” (also called “resuming from the start” or “resuming from a prior instant”), of going back in the content within a time window ranging up to four hours preceding the current instant and reading the content from an instant chosen within the time window, which is then referred to as rebroadcasting instant. To offer this function, the transmitter of contents records the multimedia content when it is broadcast live, and makes this recorded content available on request thereafter.

The inventors have found that the content read from the recorder or derived from a rewind command of “startover” type, was the same. Now, when the content relates to a content broadcast live and the rendering notes this live aspect, said startover can no longer take place. In addition, this type of expired information can disturb a user viewing the content.

The user experience is not optimal.

### SUMMARY

An aspect of the present disclosure relates to a method for managing the reading by a reading device of a content recorded on a data medium, characterized in that it comprises, upon a read mode access by the reading device to a content recorded and having been broadcast live, a request to add, during the rendering of the rebroadcast content, a datum representative of a reading of a rebroadcast content if the time between the current broadcasting instant and the rebroadcasting instant is greater than a given time.

An aspect of the present disclosure makes it possible to add a datum informing that the content being rendered, although having been broadcast live, is now broadcast as pre-recorded when the time between the current broadcasting instant and the rebroadcasting instant is greater than a given time. A user viewing the content is, in this way, informed that the content being rendered is not live when the time targeted above exceeds a given threshold; conversely, below a threshold time (for example for a pre-recorded mode reading delayed by a few seconds), there is no request to add a datum representative of a reading of a rebroadcast content. That makes it possible to both not disturb the user (if the content being rendered includes a notice of “Live” type, this notice is for example maintained) and to reduce the CPU load because the reading device does not in this case have to request the addition of data informing that the content being rendered is a rebroadcast.

According to a first embodiment, the datum representative of a reading of a rebroadcast content is included in the received data stream corresponding to the content. This mode is advantageous in that the reading device does not manage the obtaining of the datum to be displayed; this datum being transmitted by the transmitter of the content to be rendered. According to a variant, the datum representative of a reading of a recorded content could be added by the reading device. In this case, the management is handled locally.

According to a second embodiment, which will be able to be implemented alternatively or in addition to the preceding mode, the given time is included in the received data stream corresponding to the recorded content.

According to a third embodiment, which will be able to be implemented alternatively or in addition to the preceding modes, the given time is included in the transmitted data stream corresponding to the recorded content. In this mode, the reading device receives the time and is responsible for comparing the broadcasting and rebroadcasting instants.

According to a first hardware aspect, the disclosure relates to an entity for managing the reading by a reading device of a content recorded on a data medium, characterized in that the reading device comprises a processor configured to, upon a read mode access by the reading device to a content recorded and having been broadcast live, request an addition, during the rendering of the rebroadcast content, of a datum representative of a reading of a rebroadcast content if the time between the current broadcasting instant (Hc) and the rebroadcasting instant (Hr) is greater than a given time (T).

According to a second hardware aspect, the disclosure relates to a reading device comprising a management entity as defined hereinabove.

According to a third hardware aspect, the disclosure relates to a first computer program capable of being implemented on the first entity as defined hereinabove, the program comprising code instructions which, when it is run by a processor, carries out the steps of the management method defined hereinabove.

Finally, according to a fourth hardware aspect, the disclosure relates to a first data medium on which has been stored at least one series of program code instructions for the execution of a management method as defined in association with the first functional aspect.

According to a second functional aspect, the disclosure relates to a method for managing the transmission of a content via a communication link to a reading device, characterized in that it comprises, when the content is a recorded content that has been broadcast live, a transmission both of the recorded content and of a request to add, to the reading device during the rendering, a datum representative of a reading of a rebroadcast content if the time between the current broadcasting instant (Hc) and the rebroadcasting instant (Hr) is greater than a given time (T).

According to this second functional aspect, the addition request comprises values to be rendered based on a time difference between the current instant of broadcasting of the content broadcast live and a rebroadcasting instant.

According to a fifth hardware aspect, the disclosure deals with a second entity for managing the transmission of a content via a communication link to a reading device, characterized in that it comprises, when the content is a recorded content having been broadcast live, a transmission both of the recorded content and of a request to add, to the reading device during the rendering, a datum representative of a reading of a rebroadcast content if the time between the current broadcasting instant (Hc) and the rebroadcasting instant (Hr) is greater than a given time (T).

According to a sixth hardware aspect, the disclosure deals with a server comprising said second entity targeted hereinabove.

According to a seventh hardware aspect, the disclosure relates to a second computer program capable of being implemented on the second entity as defined hereinabove, the program comprising code instructions which, when it is run by a processor, carries out the steps of the transmission method defined hereinabove.

Finally, according to a fourth hardware aspect, the disclosure relates to a first data medium on which has been stored at least one series of program code instructions for the execution of a management method as defined in association with the first functional aspect.

It should be noted that a recording medium can be any entity or device capable of storing the program. For example, the medium can comprise a storage means, such as a ROM, for example a CD ROM or a microelectronic circuit ROM, or even a magnetic recording means, for example a USB key or a hard disk.

Also, such a recording medium can be a transmissible medium such as an electrical or optical signal, which can be conveyed via an electric or optical cable, wirelessly or by other means, such that the computer program that it contains can be executed remotely. The program according to an aspect of the present disclosure can in particular be downloaded over a network, for example the Internet network.

Alternatively, the recording medium can be an integrated circuit in which the program is incorporated, the circuit being adapted to execute or to be used in the execution of the above-mentioned display control method.

### BRIEF DESCRIPTION OF THE DRAWINGS

The present disclosure will be better understood on reading the following description, given by way of example and with reference to the attached drawings in which:

FIG. 1 represents a computing system on which an exemplary embodiment of the disclosure is illustrated.

FIG. 2 is a simplified block diagram of the hardware structure of the reading device.

FIG. 3 is a simplified block diagram of the hardware structure of the server.

FIG. 4 illustrates an embodiment using a function of “startover” type or which resumes the reading from a prior broadcasting instant and implementing a sliding time window.

FIG. 5 is a view of the state of the rendering on a screen over time according to one embodiment; this figure is divided into two parts, a first, top part illustrating the case where the time difference between the current broadcasting instant and the chosen rebroadcasting instant is greater than a given time, and a bottom part on which the time difference between the current broadcasting instant and the chosen rebroadcasting instant is less than a given time.

### DETAILED DESCRIPTION OF AN EXEMPLARY EMBODIMENT ILLUSTRATING THE INVENTION

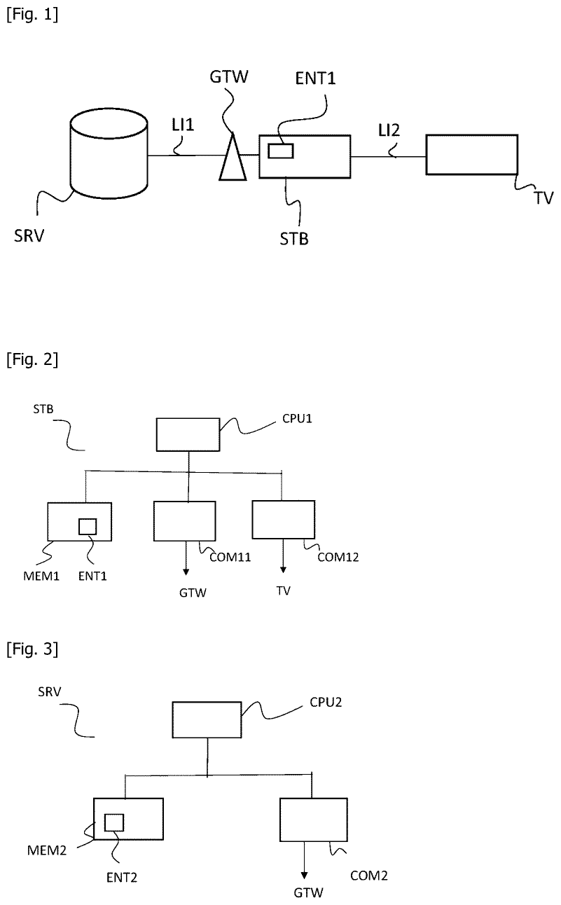

FIG. 1 represents a computing system in which is implemented a Content Distribution Network, called CDN by the person skilled in the art, from which contents are transmitted to client devices. In this example, the client devices are content reading devices.

In this example, to simplify the explanation, the system SYS comprises a single reading device STB. However, the invention applies to any number of reading devices.

The reading device STB is for example a television decoder.

The multimedia content targeted here is a video content corresponding to a television channel on which a televised program is broadcast live.

A “startover” function is provided to perform a time jump in order to reread the content from a given prior instant. This “startover” function requires a recording of the content to be able to reread the content in rebroadcast mode.

For the “startover” mode to be handled, the recording is done outside of the reading device STB, for example on the content server SRV. However, the invention can also be implemented with a local recording in the reading device STB.

In this example, the reading device STB is connected to a port of the rendering device TV, for example a television screen; the reading device STB and the rendering device TV could also form one and the same device.

In this example, the reading device STB is situated in a local area network LAN managed by a home gateway GTW.

The gateway GTW is capable of communicating via a telecommunication network LI1 such as a wide area network WAN known to the person skilled in the art.

The CDN is composed of servers networked together in the wide area network; these servers cooperate in order to make multimedia contents available to the users. In order to simplify the explanation of the invention, a single content server SRV will be represented in FIG. 1 to represent the CDN.

The content server SRV is located, in this example, in the wide area network WAN. The server SRV has several multimedia content feeds available. The content server SRV receives for example digital television content channels originating from a broadcast television network (not represented), and makes them available to the client terminals, here the reading device STB.

Among the broadcast contents, some are contents broadcast “Live”, as referred to by the person skilled in the art. This type of content has the particular feature of being transmitted over the network as soon it is captured by a capture device such as a camera.

The content server SRV also makes available contents of video-on-demand or television-on-demand type, or any other similar contents.

The contents CNT are made available in a given format. A content CNT is, for example, a content downloaded in adaptive streaming mode. The MPEG-DASH (for “Dynamic Adaptive Streaming over HTTP”) standard is a format standard for audiovisual broadcasting over the Internet; this standard is based on the preparation of the content in different representations of variable quality and bit rate, subdivided into segments of short duration (of the order of a few seconds), also called “chunks” by the person skilled in the art. Each of these segments is made available individually by means of an exchange protocol between the rendering terminal and the server providing multimedia contents. The main protocol targeted is the HTTP protocol, but other protocols (for example FTP) can also be used. The organisation of the segments and the associated parameters are published in a description file in the XML format. We will not be going further into the details of this downloading mode because it is irrelevant to the explanation of the invention.

FIG. 2 represents an architecture of a reading device STB. This device STB comprises, conventionally, memories MEM1 associated with a processor CPU1. The memories can be of ROM (for “Read Only Memory”) or RAM (for “Random Access Memory”) or even Flash type.

The decoder STB can transmit a content to be rendered to the rendering device TV via a communication module COM12. This module COM12 is for example an HDMI link.

The decoder STB communicates with the gateway via an Ethernet module for a local communication by wire or via a radio module of Wi-Fi type for a wireless local communication with the home gateway GTW. The module concerned is referenced COM11 in FIG. 2.

In this example, the decoder STB comprises a streaming mode downloading entity (not represented) capable of managing the downloading of segments in adaptive downloading mode. The invention is not limited to this downloading mode, other downloading modes can be used for the implementation of the invention, for example the IPTV downloading mode known to the person skilled in the art.

The decoder STB also comprises a management entity ENT1, called first management entity hereafter, the function of which will be described hereinbelow.

Referring to FIG. 3, the server SRV is also equipped with at least one processor CPU2 and memories MEM2 for handling the computer processing. The server is also equipped with a management entity ENT2, called second entity, capable of managing the transmission of a content from the server SRV to one or more reading devices. The server SRV communicates with the gateway GTW via a network WAN for a communication with the home gateway GTW. The module concerned is referenced COM2 in FIG. 3.

The server SRV also comprises an entity ET2, the function of which will be described in more detail hereinbelow. In this example, the role of this entity ENT2 is to transmit values, one of which is intended to be rendered at the same time as the selected content. It will also be seen that the server SRV, by implication the entity ENT2, also transmits a time T which will make it possible to choose one of the values targeted above.

A live content can be recorded and read later. For example, the content server SRV can rebroadcast the content; or else, if the content has been recorded in a local memory, it can be read directly as required from this local memory.

For example, the “startover” function introduced hereinabove makes it possible, at any moment during a reading of a content by the reading device STB, to rewind and reread the content from a prior broadcasting instant. Such a function is made possible by recording the content. In order to reduce the quantity of data to be recorded, the recording of the content is performed over a sliding time window of a given duration, for example a time window of four hours. In other words, when reading a content live, a user can request a rereading of the content which has been broadcast live from a rebroadcasting instant chosen within the fixed time window. For example, to go back to the sliding four-hour time window; if it is 8 μm, the recorded content makes it possible to go back in time up to a maximum of four hours; the user can for example go back in time by three hours and review the content as it was broadcast at 5 μm or later; if it is 8:10 pm, a rereading of a segment having been broadcast after 5:10 pm is possible.

According to the invention, when the recorded content for which access is requested is a broadcast content currently being broadcast or the live broadcast has ended, the management entity ENT1 requires a request to add a datum representative of a reading of a rebroadcast content. It will be seen hereinafter that this addition request can be made conditionally.

Remember here that, if the content is currently being rendered, the “startover” function makes it possible to make a time jump so as to reread the content from a chosen broadcasting instant.

According to a variant, the content server SRV transmits the content and an item of information indicating that the requested content is a recorded content having already been the subject of a live broadcast.

According to a variant, the entities ENT1/ENT2 can include a recognition program capable of determining whether a content is a content that has been broadcast live.

The example described hereinbelow is based on a time jump into the past by executing the “startover” function. The steps are as follows:

In a step ET1, a request to access a content broadcast live, for example a football match, is transmitted from the reading device STB to the server through the gateway GTW. Let us assume that this access is performed at 8 pm.

In a second step, the content server SRV transmits the content broadcast live.

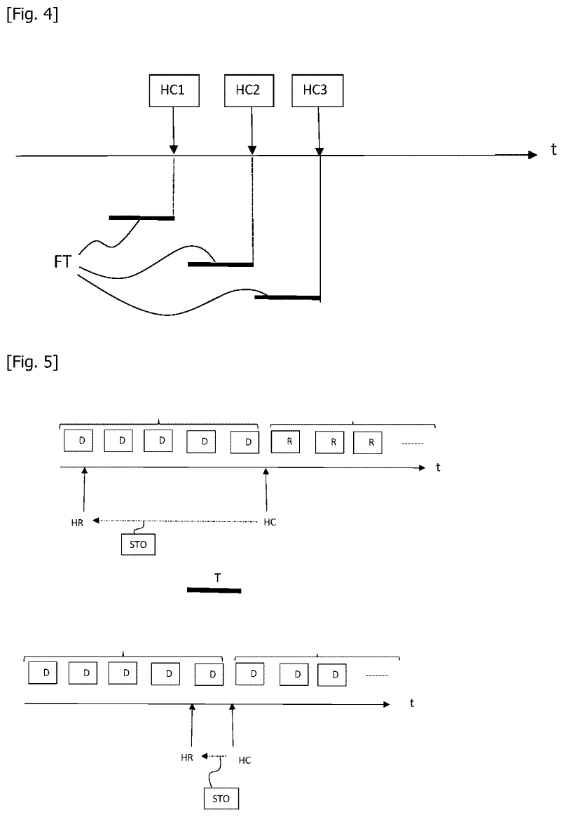

So as to offer the “startover” function, the server automatically records the content broadcast live over a sliding time window of four hours. FIG. 4 schematically illustrates the operation of a sliding time window. Three broadcasting instants Hc1, Hc2, Hc3 are represented on a time axis. The three broadcasting instants have a corresponding time window FT. During this time window FT, the content is recorded; because of the sliding nature of the time window, the segments recorded at a given instant which are no longer within the sliding time window at a subsequent instant are deleted. It is then possible to rewind in the content by selecting a rebroadcasting instant within this time window.

Let us assume that at 8:30 pm (Hc1=8:30 pm) the “startover” function is activated during the rendering of the match. A user selects a rebroadcasting instant within this time window FT to rewatch a scene of the football match.

Let us assume that the chosen rebroadcasting instant is 15 minutes prior to the current time, namely 8:15 pm.

The server SRV receives the rebroadcast request and transmits the recorded data stream in return.

In this example, since the content concerned is a content having been broadcast live, the content server SRV adds information, namely:
Two values: Live/Rebroadcast
A time T

The values are given as just two, but there could be more.

In this example, one of the two values will be rendered conditionally. The operation is as follows:

If the time between the current instant and the chosen rebroadcasting instant is less than the time T, the value «Live» is rendered on the screen.

If the time between the current instant and the chosen rebroadcasting instant is greater than the time T, the value «rebroadcast» is rendered.

This value T is for example 3 minutes. In other words, it will be considered that a time jump of less than three minutes into the past is equivalent to live, and beyond that is considered to be a rebroadcast.

On reception, the reading device STB receives the values and the time T targeted hereinabove.

In this example, the management entity ENT1 is responsible for determining the time difference between the current instant tc and the rebroadcasting instant and for comparing this difference with the value T in order to determine which of the Live and Rebroadcast values will be rendered on the television TV.

It should be noted that the time difference can be determined anywhere.

The difference is 15 minutes in this example; the management entity ENT1 requests a rendering of the “Rebroadcast” value.

A user viewing the match is then informed that the match being rendered is not live; the information can be transmitted in audible notification form and/or in the form of an image. This information will be of all the more interest to a user arriving during the match and who did not originate the activation of the “startover” function; the latter then observes that the content being rendered is a rebroadcast and not live.

According to a variant, the calculation of the time difference is not mandatory. A rebroadcast can quite simply trigger the rendering of a datum representative of a rebroadcast.

For example, if the content concerned, the match in this example, is recorded on a data medium, such as a hard disk, associated with the reading device STB. In this case, a reading can quite simply trigger the rendering of a datum representative of a reading of a recorded content. In this example, the reading device STB has only a single value “Rebroadcast”, this value being rendered as soon as a content having been broadcast live is read on the data medium.

The rendering of the values relating to live or rebroadcast can be done in several ways.

Consider for example a content recorded with the notice “Live”. In this case,

Either the time difference targeted above is less than the time T (represented on FIG. 5), in this case the indication relative to live, if there is one in the received data stream, can be maintained without modification;

Or the time difference is greater than the time T; in this case, the indication relative to live is modified. The modification can consist in removing the notice «Live» through a notice «rebroadcast».

The above two cases A and B are illustrated in FIG. 5. This FIG. 5 comprises a time axis “t” to indicate the direction of the reading of the content. FIG. 5 in the top part illustrates the case A and in the bottom part the case B.

Initially, the content is received live. The screen conventionally displays information indicating that the transmission is live with the reference D.

At a current instant Hc, an access to the startover mode STO is executed. A rebroadcast instant Hr is selected; at this stage, as indicated above, the management entity ENT1 calculates the time difference between the current time Hc and the rebroadcasting instant Hr desired for the rebroadcast and compares this difference with the given time T. In this example, the difference is greater than the time T; in this case the entity ENT1 requests the rendering of the value “Rebroadcast” referenced R on the screen.

The bottom part of FIG. 5 illustrates the case where the difference is greater than T; in this case, the management entity ENT does not modify the display. In assuming that the notice Live is not included in the content being rendered, the entity can possibly add the value “Live” referenced D to indicate that the rendering is live. In this case, the invention improves the rendering by adding information.

In both of the above cases, it is well understood that the images rendered before the current time Hc are from the Live stream and that the images rendered after the current time Hc are from a recording of the Live stream.

Finally, here, it is specified that the term module or the term entity can correspond equally to a software component and to a hardware component or a set of hardware and software components, a software component itself corresponding to one or more computer programs or sub-programs or, more generally, to any element of a program capable of implementing a function or a set of functions as described for the modules concerned. Likewise, a hardware component corresponds to any element of a hardware set capable of implementing a function or a set of functions for the module concerned (integrated circuit, chip card, memory card, et cetera).

Although the present disclosure has been described with reference to one or more examples, workers skilled in the art will recognize that changes may be made in form and detail without departing from the scope of the disclosure and/or the appended claims.

1. A management method for managing reading by a reading device of a content recorded on a data medium, wherein the method comprises:
upon a read mode access by the reading device to a content recorded and having been broadcast live, requesting to add, during a rendering of the recorded content rebroadcast, a datum representative of the reading of recorded content if the time between a current broadcasting instant and a rebroadcasting instant for the recorded content is greater than a given time.

2. The management method according to claim 1, wherein the datum representative of a reading of the content rebroadcast is included in a received data stream corresponding to the content.

3. The management method according to claim 1, wherein the datum representative of a reading of the recorded content is added by the reading device.

4. The management method according to claim 1, wherein the given time is included in a received data stream corresponding to the recorded content.

5. A reading device for reading a content recorded on a data medium, wherein the reading device comprises:
a processor configured to, upon a read mode access by the reading device to a content recorded and having been broadcast live, request an addition, during a rendering of the recorded content rebroadcast, of a datum representative of the reading of the recorded content if the time between a current broadcasting instant and a rebroadcasting instant for the recorded content is greater than a given time.

6. A non-transitory computer readable medium comprising instructions stored thereon which when executed by a processor, carries out the method defined in claim 1.

7. A method for managing transmission of a content via a communication link to a reading device, wherein the content is a recorded content having been broadcast live, wherein the method comprises:
transmitting to the reading device both the recorded content and a request to add, during a rendering, a datum representative of a reading of a rebroadcast content if a time between a current broadcasting instant and a rebroadcasting instant for the recorded content is greater than a given time.

8. An entity for managing transmission of a content via a communication link to a reading device, wherein the content is a recorded content having been broadcast live, and the entity comprises:
a processor configured to transmit to the reading device both the recorded content and a request to add, during a rendering, a datum representative of a reading of a rebroadcast content if the time between a current broadcasting instant and a rebroadcasting instant for the recorded content is greater than a given time.

9. Server comprising the entity as defined in claim 8.

10. A non-transitory computer readable medium comprising instructions stored thereon which when executed by a processor, carries out the method defined in claim 7.
